(19) United States
(12) Patent Application Publication
(10) Pub. No.: US 2021/0319170 A1
(43) Pub. Date: Oct. 14, 2021

(54) System and Method for Generating a Dynamic Document

(71) Applicant: Capital One Services, LLC, McLean, VA (US)

(72) Inventor: Robert W. Hebert, Wylie, TX (US)

(73) Assignee: Capital One Services, LLC, McLean, VA (US)

(21) Appl. No.: 16/844,351

(22) Filed: Apr. 9, 2020

(51) Int. Cl. G06F 40/174; G06Q 10/10; G06F 16/93; G06F 40/205; H04L 29/08

(52) U.S. Cl. CPC G06F 40/174; G06Q 10/10; H04L 67/34; G06F 40/205; G06F 16/93

(57) ABSTRACT

A system and method for dynamically updating a document having a plurality of modifiable fields are disclosed herein. The document receives one or more inputs for one or more fields contained in the document. The macro processor parses the one or more fields to identify the one or more inputs contained therein. The macro processor compares the one or more inputs to one or more rules defined in a macro associated with the document. Based on the comparing, the macro processor modifies the document to include a subset of modifiable fields. The macro processor generates an updated document that includes the subset of modifiable fields. A computing system presents the updated document to an end user for modification.

### FIELD OF THE DISCLOSURE

The present disclosure generally relates to a system and method of generating a dynamic document.

### BACKGROUND

The loan application process is conventionally a tedious, time consuming, process that involves the borrower parsing through hundreds, if not thousands, of fields, some of which may not be relevant to the loan being sought. As a result, there is a burden on the lender to streamline, such process for purposes of generating a loan application and for purposes of reducing confusion of the borrower when filling out such application.

### SUMMARY

In some embodiments, a method for dynamically updating a document having a plurality of modifiable fields is disclosed herein. The document receives one or more inputs for one or more fields contained in the document. The macro processor parses the one or more fields to identify the one or more inputs contained therein. The macro processor compares the one or more inputs to one or more rules defined in a macro associated with the document. Based on the comparing, the macro processor modifies the document to include a subset of modifiable fields. The macro processor generates an updated document that includes the subset of modifiable fields. A computing system presents the updated document to an end user for modification.

In some embodiments, receiving, via the document, the one or more inputs for the one or more fields contained in the document includes receiving, via a drop-down menu, a selection of an option of a plurality of options associated with a respective field.

In some embodiments, generating, by the macro processor, the updated document comprising the plurality of modifiable fields includes, for each possible field of the plurality of modifiable fields, determining a significance of that respective possible field based on the one or more inputs and removing a set of possible fields that are irrelevant based on the one or more inputs.

In some embodiments, generating, by the macro processor, the updated document comprising the plurality of modifiable fields includes identifying a set of modifiable fields related to an input of the one or more inputs and prepopulating data into the set of modifiable fields based on the input of the one or more inputs.

In some embodiments, a client device requests the document from a web server associated with a loan organization. The client device downloads the document from the web server. The document includes the macro processor and the macros associated therewith.

In some embodiments, the macro includes one or more instructions for the macro processor to populate related fields with data provided by the one or more inputs.

In some embodiments, the document is a loan application checklist.

In some embodiments, a system is disclosed herein. The system includes a processor and a memory. The memory has programming instructions stored thereon, which, when executed by the processor, performs one or more operations. The one or more operations include receiving, via a loan application document, one or more inputs for one or more fields contained in the loan application document. The one or more fields relate to borrower information, guarantor information, and collateral information. The one or more operations further include parsing, by a macro processor, the one or more fields to identify the one or more inputs contained therein. The one or more operations further include comparing, by the macro processor, the one or more inputs related to the borrow information, the guarantor information, and the collateral information to one or more rules defined in a macro associated with the loan application document. The one or more operations further include, based on the comparing, modifying, by the macro processor, the loan application document to include a subset of modifiable fields. The one or more operations further include generating, by the macro processor, an updated loan application document comprising the subset of modifiable fields. The one or more operations further include presenting the updated loan application document to an end user for modification.

In some embodiments, receiving, via the loan application document the one or more inputs for the one or more fields contained in the loan application document includes receiving, via a drop-down menu, a selection of an option of a plurality of options associated with a respective field.

In some embodiments, generating, by the macro processor, the updated document that includes the plurality of modifiable fields includes for each possible field of the plurality of modifiable fields, determining a significance of that respective possible field based on the one or more inputs and removing, by the macro processor, a set of possible fields that are irrelevant based on the one or more inputs.

In some embodiments, generating, by the macro processor, the updated loan application document comprising the plurality of modifiable fields includes identifying a set of modifiable fields related to an input of the one or more inputs and prepopulating data into the set of modifiable fields based on the input of the one or more inputs.

In some embodiments, the one or more operations further include requesting, by a client device, the loan application document from a web server associated with a loan organization. The one or more operations further include downloading, by the client device, the loan application document from the web server, the loan application document comprising the macro processor and the macros associated therewith.

In some embodiments, the macro includes one or more instructions for the macro processor to populate related fields with data provided by the one or more inputs.

In some embodiments, a non-transitory computer readable medium is disclosed herein. The non-transitory computer readable medium includes one or more sequences of instructions that, when executed by the one or more processors, causes one or more operations. The one or more operations include receiving, via the document, one or more inputs for one or more fields contained in the document. The one or more operations further include parsing, by a macro processor, the one or more fields to identify the one or more inputs contained therein. The one or more operations further include comparing, by the macro processor, the one or more inputs to one or more rules defined in a macro associated with the document. The one or more operations further include, based on the comparing, modifying, by the macro processor, the document to include a subset of modifiable fields. The one or more operations further include generating, by the macro processor, an updated document comprising the subset of modifiable fields. The one or more operations further include presenting the updated document to an end user for modification.

In some embodiments, receiving, via the document the one or more inputs for the one or more fields contained in the document include receiving, via a drop-down menu, a selection of an option of a plurality of options associated with a respective field.

In some embodiments, generating, by the macro processor, the updated document comprising the plurality of modifiable fields includes for each possible field of the plurality of modifiable fields, determining a significance of that respective possible field based on the one or more inputs and removing, by the macro processor, a set of possible fields that are irrelevant based on the one or more inputs.

In some embodiments, generating, by the macro processor, the updated document comprising the plurality of modifiable fields includes identifying a set of modifiable fields related to an input of the one or more inputs and prepopulating data into the set of modifiable fields based on the input of the one or more inputs.

In some embodiments, the one or more operations further include requesting, by a client device, the document from a web server associated with a loan organization. The one or more operations further include downloading, by the client device, the document from the web server, the document comprising the macro processor and the macros associated therewith.

In some embodiments, the macro includes one or more instructions for the macro processor to populate related fields with data provided by the one or more inputs.

In some embodiments, the document is a loan application checklist.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a flow diagram illustrating a method of dynamically generating a loan application checklist, according to example embodiments.

FIG. 3 is a block diagram illustrating a graphical user interface, according to example embodiments.

FIG. 4 is a block diagram illustrating a computing environment, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

One or more techniques disclosed herein generally relate to a system and method of generating a dynamic document. For example, traditionally, the loan closing process involves a checklist attached to each loan packet to document the steps taken and information gathered to close the loan. A loan department typically closes several different types of loans with many variables (e.g., number and type of borrowers, number and type of guarantors, number and type of collateral, and the like), which may result in a checklist that involves hundreds, if not thousands, of fields. One or more techniques described herein attempt to streamline such process to only include applicable items to the loan being sought, resulting in a checklist that can be as short as one page. Such process would save a great deal of time for the borrower and the lender.

To achieve such process, the one or more techniques described herein implements various macroinstructions (“macros”) defining one or more rules for generating an updated loan application. For example, given an initial set of inputs that define the type of loan being sought, a macro processor may parse the loan application to activate or inactivate certain fields or rows of the checklist, thereby only presenting the user with fields applicable to this particular loan process.

The term “user” as used herein includes, for example, a person or entity that owns a computing device or wireless device; a person or entity that operates or utilizes a computing device; or a person or entity that is otherwise associated with a computing device or wireless device. It is contemplated that the term “user” is not intended to be limiting and may include various examples beyond those described.

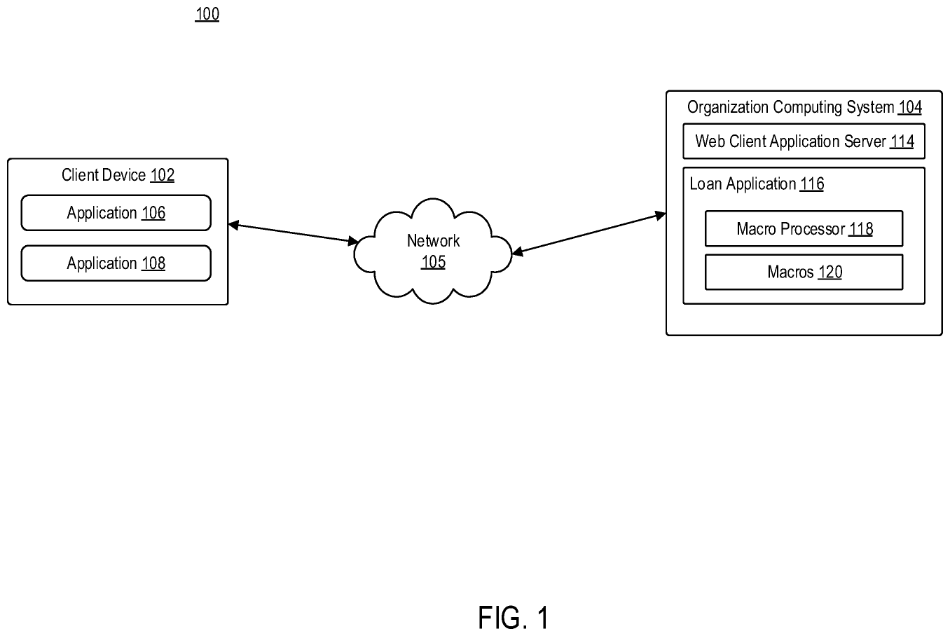

FIG. 1 is a block diagram illustrating a computing environment 100, according to one embodiment. Computing environment 100 may include at least a client device 102 and an organization computing system 104 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™ ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of system 100.

Client device 102 may be operated by a user. For example, client device 102 may be a mobile device, a tablet, a desktop computer, or any computing system having the capabilities described herein. Client device 102 may belong to or be provided to a user or may be borrowed, rented, or shared. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 102 may include at least application 106 and application 108. Application 106 may be representative of a web browser that allows access to a website or a stand-alone application. Client device 102 may access application 106 to access functionality of organization computing system 104. For example, client device 102 may access application 106 to access an loan application 116 hosted by organization computing system 104. Application 108 may be representative of a document editing tool. For example, application 108 may be representative of a word processing application, a spreadsheet application, or any application capable of performing the functions disclosed herein.

Organization computing system 104 may include at least web client application server 114 and loan application 116. Loan application 116 may be representative of a loan application for an organization associated with organization computing system 104. In some embodiments, loan application 116 may be representative of a spreadsheet-based checklist. For example, loan application 116 may include several fields that are editable by the user. The several fields may prompt the user to describe parameters of the loan being sought. Generally, the entire loan application 116 may include several hundred, if not thousand, fields to accommodate any foreseeable loan. Given the inputs in the several fields mentioned above, loan application 116 may build itself based on the selections made. In other words, loan application 116 may selectively remove fields not relevant to the type of loan sought by the applicant, so that the loan application process may be more streamlined.

Loan application 116 may include macro processor 118 and one or more macros 120. Macro processor 118 may be a component or module configured to execute one or more macros 120 associated with loan application 116. Macros 120 may be representative of a microinstruction (e.g., a rule or pattern) that specifies a given procedure. For example, macro processor 118 may analyze one or more inputs provided to the several fields mentioned above in loan application 116. Macro processor 118 may compare the one or more inputs to the various rules of macros 120 to determine how to generate (or build) loan application. In other words, macros 120 may define which of the several hundred (or thousand) fields to present to the user, given the various inputs that define the type of loan being sought.

Upon receiving a request for a loan application, organization computing system 104 may allow client device 102 to download loan application 116. Loan application 116 may be representative of a loan application template provided to the user. When downloaded, loan application 116 may include macro processor 118 and macros 120 associated therewith, such that client device 102 can edit loan application 116 locally, while retaining the functionalities of macro processor 118 and macros 120.

In some embodiments, client device 102 may not download loan application 116. Rather, client device 102 may access loan application 116 via application 106. Via application 106, a user may edit loan application 116 using a cloud-based document editing tool (e.g., Microsoft® Office 365).

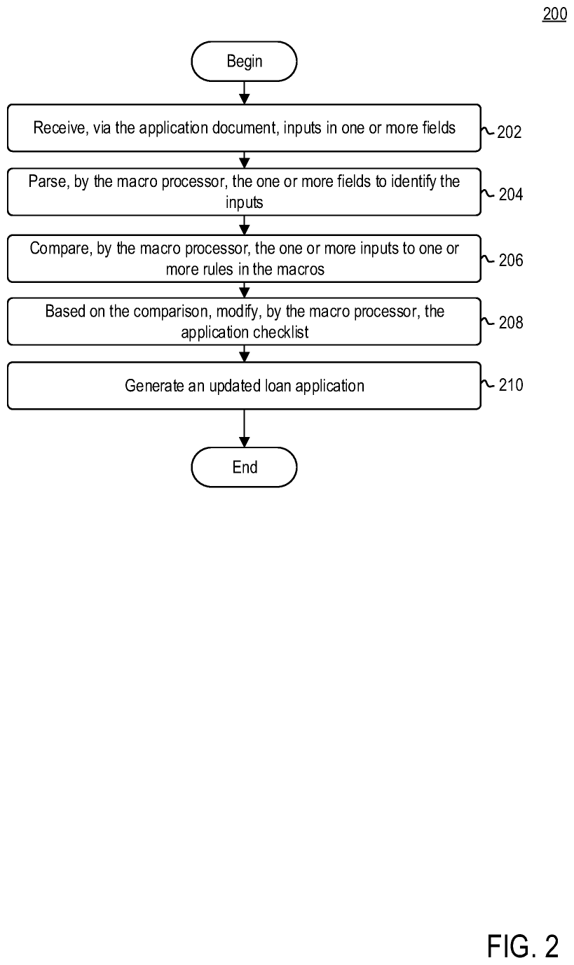

FIG. 2 is a flock diagram illustrating a method 200 of dynamically generating a loan application checklist, according to example embodiments. Method 200 may begin at step 202.

At step 202, application 108 may receive one or more inputs via one or more fields contained therein. For example, in some embodiments, client device 102 may have downloaded loan application 116 from organization computing system 104. Client device 102 may open loan application 116 in application 108. In some embodiments, client device 102 may access loan application 116 via application 106. The one or more inputs via the one or more fields of application 108 may correspond to one or more parameters describing the loan being sought. For example, the one or more inputs may correspond to information directed to borrower information, guarantor information, collateral information, a combination thereof, and the like. In some embodiments, additional information includes product type (loan, line of credit, letter of credit, renewal, loan modification) and product information (amount in dollars, existing loan number for renewals, approval date). In some embodiments, the one or more inputs may be received via a modifiable text field. In some embodiments, the one or more inputs may be received via a drop-down bar.

At step 204, macro processor 118 may parse the one or more fields to identify the inputs contained therein. For example, receipt of the inputs may prompt macro processor 118 to identify the inputs for further analysis. At step 206, macro processor 118 may compare the one or more inputs to one or more rules defined in macros 120. For example, macro processor 118 may execute macros 120 to determine which editable fields of loan application 116 to remove therefrom, given the inputs. In other words, given the type of loan being sought (as defined from the initial inputs), macro processor 118 may switch on (or off) various editable fields.

At step 208, based on the comparison, macro processor 118 may modify loan application 116. For example, based on determining which fields to turn on or off (e.g., make active/inactive), macro processor 118 may dynamically update loan application 116 to reflect such determination. At step 210, macro processor 118 may generate an updated loan application for the end user.

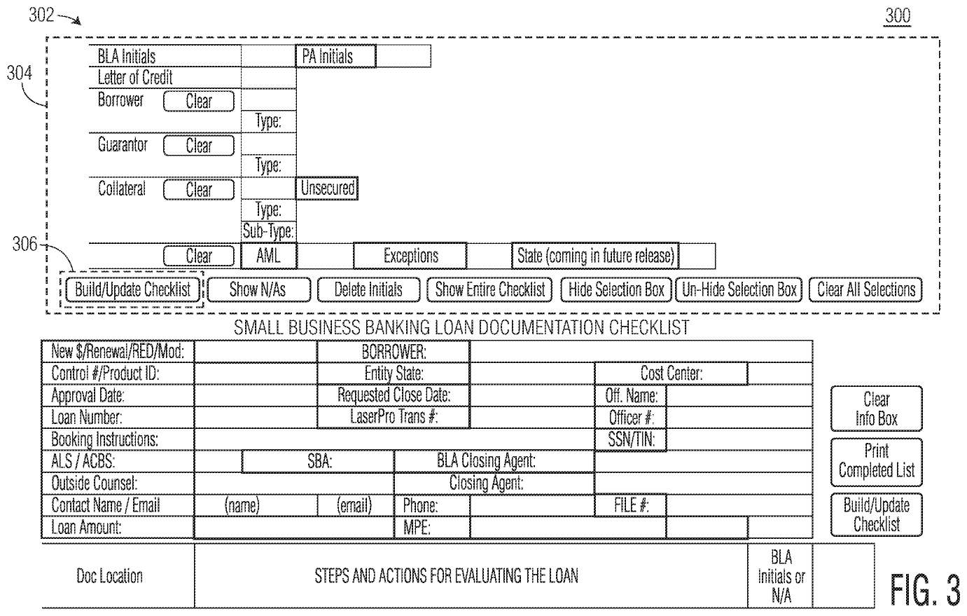

FIG. 3 is a block diagram illustrating a graphical user interface (GUI) 300 illustrating a loan application (e.g., loan application 116) according to example embodiments. GUI 300 only illustrates a portion of loan application 302.

As illustrated loan application 302 may include an initial input portion 304. Initial input portion 304 may include one or more fields modifiable by end user. The one or more fields may help dictate the type of loan being sought by the user. For example, as illustrated, the one or more fields may represent information directed to the letter of credit, such as, but not limited to, borrower information, guarantor information, collateral information and the like. Once said information is input in initial input portion 304, a user may interact with “build/update checklist” button 306. Interaction with button 306 may trigger macro processor 118 to parse loan application 302 to determine which subsequent fields to activate/inactivate, given the parameters of the loan.

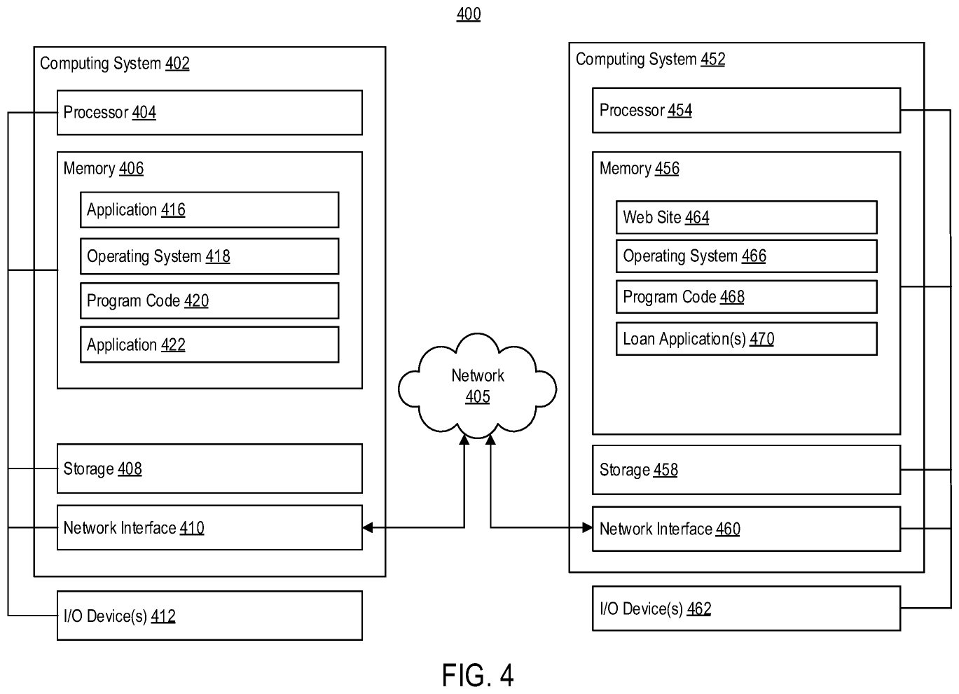

FIG. 4 is a block diagram 400 visually representing various paths through website, according to example embodiments. The example provided in block diagram 400 is of a user interacting with a log-in prompt.

FIG. 4 is a block diagram illustrating an exemplary computing environment 400, according to some embodiments. Computing environment 400 includes computing system 402 and computing system 452. Computing system 402 may be representative of client device 102. Computing system 452 may be representative of organization computing system 104.

Computing system 402 may include a processor 404, a memory 406, a storage 408, and a network interface 410. In some embodiments, computing system 402 may be coupled to one or more I/O device(s) 412 (e.g., keyboard, mouse, etc.).

Processor 404 may retrieve and execute program code 420 (i.e., programming instructions) stored in memory 406, as well as stores and retrieves application data. Processor 404 may be included to be representative of a single processor, multiple processors, a single processor having multiple processing cores, and the like. Network interface 410 may be any type of network communications allowing computing system 402 to communicate externally via computing network 405. For example, network interface 410 is configured to enable external communication with computing system 452.

Storage 408 may be, for example, a disk storage device. Although shown as a single unit, storage 408 may be a combination of fixed and/or removable storage devices, such as fixed disk drives, removable memory cards, optical storage, network attached storage (NAS), storage area network (SAN), and the like.

Memory 406 may include application 416, operating system 418, program code 420, and application 422. Program code 420 may be accessed by processor 404 for processing (i.e., executing program instructions). Program code 420 may include, for example, executable instructions for communicating with computing system 452 to display one or more pages of website 464. Application 416 may enable a user of computing system 402 to access a functionality of computing system 452. For example, application 416 may access content managed by computing system 452, such as loan application 470. The content that is displayed to a user of computing system 402 may be transmitted from computing system 452 to computing system 402, and subsequently processed by application 416 for display through a graphical user interface (GUI) of computing system 402. Application 422 may be representative of a document editing tool. For example, application 422 may be representative of a word processing application, a spreadsheet application, or any application capable of performing the functions disclosed herein.

Computing system 452 may include a processor 454, a memory 456, a storage 458, and a network interface 460. In some embodiments, computing system 452 may be coupled to one or more I/O device(s) 462.

Processor 454 may retrieve and execute program code 466 (i.e., programming instructions) stored in memory 456, as well as stores and retrieves application data. Processor 454 is included to be representative of a single processor, multiple processors, a single processor having multiple processing cores, and the like. Network interface 460 may be any type of network communications enabling computing system 452 to communicate externally via computing network 405. For example, network interface 460 allows computing system 452 to communicate with computer system 402.

Storage 458 may be, for example, a disk storage device. Although shown as a single unit, storage 458 may be a combination of fixed and/or removable storage devices, such as fixed disk drives, removable memory cards, optical storage, network attached storage (NAS), storage area network (SAN), and the like.

Memory 456 may include website 464, operating system 466, program code 468, and one or more loan applications 470 (hereinafter “loan application 470”). Program code 468 may be accessed by processor 454 for processing (i.e., executing program instructions). Program code 468 may include, for example, executable instructions configured to perform steps discussed above in conjunction with FIG. 2. Website 464 may be accessed by computing system 402. For example, website 464 may include content accessed by computing system 402 via a web browser or application.

Loan application 470 may be representative of a loan application for an organization associated with computing system 452. In some embodiments, loan application 470 may be representative of a spreadsheet-based checklist. For example, loan application 470 may include several fields that are editable by the user. The several fields may prompt the user to describe parameters of the loan being sought. Generally, the entire loan application 470 may include several hundred, if not thousand, fields to accommodate any foreseeable loan. Given the inputs in the several fields mentioned above, loan application 470 may build itself based on the selections made. In other words, loan application 470 may selectively remove fields not relevant to the type of loan sought by the applicant, so that the loan application process may be more streamlined.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method for dynamically updating a document having a plurality of modifiable fields, comprising:
executing a local application for editing the document, the document macros defining one or more rules associated with the document;
loading the document in the local application;
receiving, via the local application, one or more inputs for one or more fields contained in the document;
parsing, by a macro processor, the one or more fields to identify the one or more inputs contained therein;
comparing, by the macro processor, the one or more inputs to the one or more rules defined in the macro associated with the document;
based on the comparing, modifying, by the macro processor, the document to include a subset of modifiable fields;
generating, by the macro processor, an updated document comprising the subset of modifiable fields; and
presenting the updated document to an end user for modification.

2. The method of claim 1, wherein receiving, via the document the one or more inputs for the one or more fields contained in the document, comprises:
receiving, via a drop-down menu, a selection of an option of a plurality of options associated with a respective field.

3. The method of claim 1, wherein generating, by the macro processor, the updated document comprising the plurality of modifiable fields comprises:
for each possible field of the plurality of modifiable fields, determining a significance of that respective possible field based on the one or more inputs; and
removing, by the macro processor, a set of possible fields that are irrelevant based on the one or more inputs.

4. The method of claim 1, wherein generating, by the macro processor, the updated document comprising the plurality of modifiable fields comprises:
identifying a set of modifiable fields related to an input of the one or more inputs; and
prepopulating data into the set of modifiable fields based on the input of the one or more inputs.

5. The method of claim 1, further comprising:
requesting, by a client device, the document from a web server associated with a loan organization; and
downloading, by the client device, the document from the web server, the document comprising the macro processor and the macros associated therewith.

6. The method of claim 1, wherein the macro comprises one or more instructions for the macro processor to populate related fields with data provided by the one or more inputs.

7. The method of claim 1, wherein the document is a loan application checklist.

8. A system, comprising:
a processor; and
a memory having programming instructions stored thereon, which, when executed by the processor, performs one or more operations, comprising:
executing a local application for editing a loan application document, the loan application document macros defining one or more rules associated with the loan application document;
loading the loan application document in the local application;
receiving, via the loan application document, one or more inputs for one or more fields contained in the loan application document, the one or more fields related to borrow information, guarantor information, and collateral information;
parsing, by a macro processor, the one or more fields to identify the one or more inputs contained therein;
comparing, by the macro processor, the one or more inputs related to the borrow information, the guarantor information, and the collateral information to the one or more rules defined in the macro associated with the loan application document;
based on the comparing, modifying, by the macro processor, the loan application document to include a subset of modifiable fields;
generating, by the macro processor, an updated loan application document comprising the subset of modifiable fields; and
presenting the updated loan application document to an end user for modification.

9. The system of claim 8, wherein receiving, via the loan application document the one or more inputs for the one or more fields contained in the loan application document, comprises:
receiving, via a drop-down menu, a selection of an option of a plurality of options associated with a respective field.

10. The system of claim 8, wherein generating, by the macro processor, the updated document comprising the plurality of modifiable fields comprises:
for each possible field of the plurality of modifiable fields, determining a significance of that respective possible field based on the one or more inputs; and
removing, by the macro processor, a set of possible fields that are irrelevant based on the one or more inputs.

11. The system of claim 8, wherein generating, by the macro processor, the updated loan application document comprising the plurality of modifiable fields comprises:
identifying a set of modifiable fields related to an input of the one or more inputs; and
prepopulating data into the set of modifiable fields based on the input of the one or more inputs.

12. The system of claim 8, further comprising:
requesting, by a client device, the loan application document from a web server associated with a loan organization; and
downloading, by the client device, the loan application document from the web server, the loan application document comprising the macro processor and the macros associated therewith.

13. The system of claim 8, wherein the macro comprises one or more instructions for the macro processor to populate related fields with data provided by the one or more inputs.

14. A non-transitory computer readable medium including one or more sequences of instructions that, when executed by the one or more processors, causes:
executing a local application for editing a document, the document comprising macros defining one or more rules associated with the document;
loading the document in the local application;
receiving, via the local application, one or more inputs for one or more fields contained in the document;
parsing, by a macro processor, the one or more fields to identify the one or more inputs contained therein;
comparing, by the macro processor, the one or more inputs to the one or more rules defined in the macro associated with the document;
based on the comparing, modifying, by the macro processor, the document to include a subset of modifiable fields;
generating, by the macro processor, an updated document comprising the subset of modifiable fields; and
presenting the updated document to an end user for modification.

15. The non-transitory computer readable medium of claim 14, wherein receiving, via the document the one or more inputs for the one or more fields contained in the document, comprises:
receiving, via a drop-down menu, a selection of an option of a plurality of options associated with a respective field.

16. The non-transitory computer readable medium of claim 14, wherein generating, by the macro processor, the updated document comprising the plurality of modifiable fields comprises:
for each possible field of the plurality of modifiable fields, determining a significance of that respective possible field based on the one or more inputs; and
removing, by the macro processor, a set of possible fields that are irrelevant based on the one or more inputs.

17. The non-transitory computer readable medium of claim 14, wherein generating, by the macro processor, the updated document comprising the plurality of modifiable fields comprises:
identifying a set of modifiable fields related to an input of the one or more inputs; and
prepopulating data into the set of modifiable fields based on the input of the one or more inputs.

18. The non-transitory computer readable medium of claim 14, further comprising:
requesting, by a client device, the document from a web server associated with a loan organization; and
downloading, by the client device, the document from the web server, the document comprising the macro processor and the macros associated therewith.

19. The non-transitory computer readable medium of claim 14, wherein the macro comprises one or more instructions for the macro processor to populate related fields with data provided by the one or more inputs.

20. The non-transitory computer readable medium of claim 14, wherein the document is a loan application checklist.
